(19) United States
(12) Patent Application Publication
(10) Pub. No.: US 2024/0161959 A1
(43) Pub. Date: May 16, 2024

(54) MODULE STRUCTURE AND ITS MANUFACTURING METHOD

(71) Applicant: Silergy Semiconductor Technology (Hangzhou) LTD, Hangzhou (CN)

(72) Inventors: Ke Dai, Hangzhou (CN); Jian Wei, Hangzhou (CN); Jiajia Yan, Hangzhou (CN); Chen Zhao, Hangzhou (CN)

(21) Appl. No.: 18/386,317

(22) Filed: Nov. 2, 2023

(30) Foreign Application Priority Data
Nov. 11, 2022 (CN) 202211420564.1
Sep. 20, 2023 (CN) 202311219613.X

(51) Int. Cl. H01F 27/02; H01F 27/24; H01F 27/29; H01F 27/40

(52) U.S. Cl. CPC H01F 27/022; H01F 27/24; H01F 27/29; H01F 27/40

(57) ABSTRACT

A module structure can include a first type structure including a first encapsulation body having a magnetic property, and at least one inductive element, where at least part of the inductive element is encapsulated in the first encapsulation body; a second type structure including a second encapsulation body having a non-magnetic property, and at least one non-inductive element, where the non-inductive element is encapsulated in the second encapsulation body; and pin structures located on exposed surfaces of the first type structure and/or the second type structure, in order to lead out corresponding electrodes.

### RELATED APPLICATIONS

This application claims the benefit of Chinese Patent Application No. 202311219613.X, filed on Sep. 20, 2023, which claims the benefit of Chinese Patent Application No. 202211420564.1, filed on Nov. 11, 2022, both of which are incorporated herein by reference in their entirety.

### FIELD OF THE INVENTION

The present invention generally relates to the field of semiconductor technology, and more particularly to module structures and methods.

### BACKGROUND

In recent years, more and more power module products have been used in applications with high space requirements. Simple and small-sized power supply modules can be used, which are increasingly favored by customers. Power module products usually integrate purchased inductors inside the module. The simplest module includes a substrate (e.g., printed-circuit board [PCB]) that seals the chip die and an inductor welded thereto. Due to installation tolerance limitations of the inductor, purchased inductors typically cannot fully utilize the space, especially for smaller modules.

### BRIEF DESCRIPTION OF THE DRAWINGS

FIG. 1 is a three-dimensional structural diagram of a module structure, in accordance with embodiments of the present invention.

FIG. 2 is a three-dimensional structural diagram of a first type structure, in accordance with embodiments of the present invention.

FIG. 3 is a cross-sectional diagram of a first example module structure, in accordance with embodiments of the present invention.

FIG. 4 is a cross-sectional diagram of a second example module structure, in accordance with embodiments of the present invention.

FIG. 5 is a cross-sectional diagram of a third example module structure, in accordance with embodiments of the present invention.

FIG. 6 is a cross-sectional diagram of a fourth example module structure, in accordance with embodiments of the present invention.

FIG. 7 is a cross-sectional diagram of a fifth example module structure, in accordance with embodiments of the present invention.

FIG. 8 is a cross-sectional diagram of a sixth example module structure, in accordance with embodiments of the present invention.

FIG. 9 is a cross-sectional diagram of a seventh example module structure, in accordance with embodiments of the present invention.

FIG. 10 is a cross-sectional diagram of an eighth example module structure, in accordance with embodiments of the present invention.

FIG. 11 is a cross-sectional diagram of a ninth example module structure, in accordance with embodiments of the present invention.

FIG. 12 is a cross-sectional diagram of a tenth example module structure, in accordance with embodiments of the present invention.

FIG. 13 is a cross-sectional diagram of a eleventh example module structure, in accordance with embodiments of the present invention.

FIG. 14 is a cross-sectional diagram of a twelfth example module structure, in accordance with embodiments of the present invention.

FIG. 15 is a cross-sectional diagram of a thirteenth example module structure, in accordance with embodiments of the present invention.

FIG. 16 is a cross-sectional diagram of a fourteenth example module structure, in accordance with embodiments of the present invention.

FIGS. 17A-17E are structural diagrams corresponding to certain steps of a manufacturing method for a module structure, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

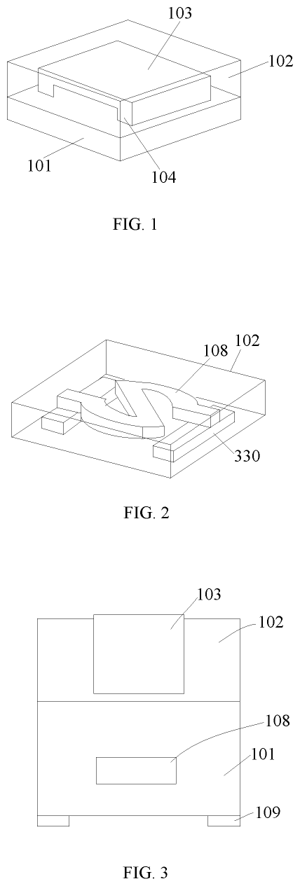

Referring now to FIG. 1, shown is a three-dimensional structural diagram of a module structure, in accordance with embodiments of the present invention. In this particular example, the module structure can include a first type structure, a second type structure, and pin structures. The first type structure can include encapsulation body 102 having magnetic property and inductive element 103, where the first encapsulation body is formed by magnetic material, and at least part of inductive element 103 can be encapsulated by encapsulation body 102. The second type structure can include encapsulation body 101 having non-magnetic property and a non-inductive element, encapsulation body 101 is formed by non-magnetic materials, and the non-inductive element is encapsulated by the second encapsulation body. For example, the pin structures can be located on exposed surfaces of the first type structure and/or the second type structure, and corresponding electrodes may be led out by the pin structures.

In particular embodiments, encapsulation body 102 can include an insulating main material and magnetic particles dispersed in the insulating main material. The magnetic particles can include at least one of carbonyl iron powder, alloy powder, micro-particle broken ferrite powder, and amorphous nanocrystalline powder, such as alloy particles of elements such as Fe, Si, NI, Cr, AL, Cu, etc. For example, the insulating main material can include at least one of epoxy resin, phenolic resin, cyanate ester, polyester resin, bismaleimide, and silicone resin.

In particular embodiments, inductive element 103 can be one of transformers or inductors. Here, inductive element 103 is an inductor as an example to illustrate. In this example, non-inductive elements can include one or more of resistors, capacitors, and dies. For example, the die can include integrated circuits as an example. Integrated circuits, also known as microcircuits, microchips, and chips, are a way of miniaturizing circuits (mainly including semiconductor devices and passive components) in electronics and are typically manufactured on the surface of semiconductor wafers. In other examples, the die can also be a thyristor, field-effect transistor, and other devices. In other examples, non-inductive elements can also be one or more of electronic tubes, Hall devices, optoelectronic devices, electroacoustic devices, surface mount devices, integrated circuits, and optocouplers.

In particular embodiments, encapsulation body 101 can be an insulating material, For example, encapsulation body 101 can include various printed-circuit boards (PCBs), ceramic materials, and packaging substrate BT boards in addition to epoxy resin packaging materials. In this example, the pin structures can include two types: input pins and output pins. The input pins and output pins can be set on the exposed surfaces of the first type structure and/or the second type structure, and the specific positions of the input pins and output pins on the exposed surfaces of the first type structure and/or the second type structure can be determined according to the particular application. The input pins and output pins can be electrically connected to inductive element 103 and non-inductive element 103, respectively. The input pins and output pins can be used to lead out the electrodes of inductive element 103 and non-inductive element. In addition, the connection between inductive component 103 and the non-inductive element can also be through the input pin and output pin.

In particular embodiments, at least part of inductive element 103 can be encapsulated by the first encapsulation body, such that inductive element 103 can be completely encapsulated within encapsulation body 102. Alternatively, a part of inductive element 103 can be encapsulated within encapsulation body 102, and the remaining part of inductive element 103 may be exposed at the outside of encapsulation body 102. For example, the remaining part of inductive element 103 can be exposed at the upper surface of encapsulation body 102, or can be exposed at the lower surface of encapsulation body 102. For example, the exposed part of inductive element 103 can be located at a specific position in encapsulation body 102, which can be determined according to the particular application.

Referring now to FIG. 3, shown is a cross-sectional diagram of a first example module structure, in accordance with embodiments of the present invention. In this particular example, the first type structure is arranged on an upper end of the second type structure, and the pin structures are arranged on the exposed surfaces of the second type structure. For example, encapsulation body 102 may only encapsulate a part of inductive element 103, and expose the remaining part of inductive element 103 at the upper surface of encapsulation body 102, while non-inductive element 108 can be encapsulated within encapsulation body 101. In addition, both the input pins and output pins can be set on the exposed surfaces of the second type structure; that is, the input pins and output pins may both be set on the lower surface of encapsulation body 102. In this way, the heat dissipation effect of inductive element 103 can be improved as the part of inductive elements 103 are exposed at the upper surface of encapsulation body 102. In other examples, the input pins and output pins can also be set on other surfaces of encapsulation body 102, and specific setting on which surface of encapsulation body 102 depends on the particular application.

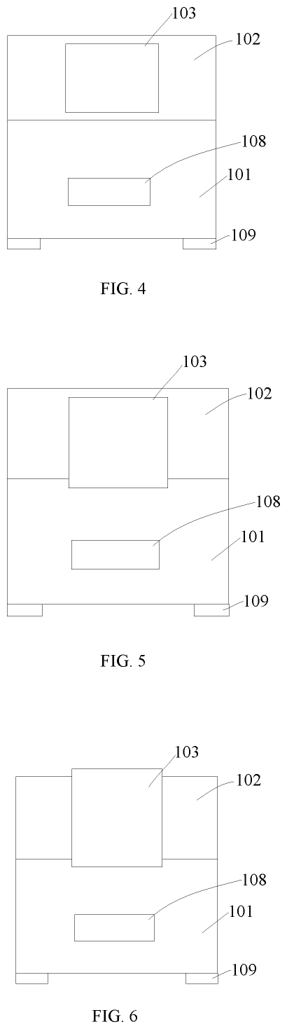

Referring now to FIG. 4, shown is a cross-sectional diagram of a second example module structure, in accordance with embodiments of the present invention. In this particular example, inductive element 103 can be fully encapsulated within encapsulation body 102; that is inductive element 103 may not be exposed by the outer surface of encapsulation body 102.

Referring now to FIG. 5, shown is a cross-sectional diagram of a third example module structure, in accordance with embodiments of the present invention. In this particular example, part of inductive element 103 can be exposed by encapsulation body 102. Here, the exposed part of inductive element 103 may be set on the lower surface of encapsulation body 102, and the exposed part of inductive element 103 on the lower surface of packaging body 102 can be encapsulated in second packaging body 101.

Referring now to FIG. 6, shown is a cross-sectional diagram of a fourth example module structure, in accordance with embodiments of the present invention. In this particular example, part of inductive element 103 can be exposed by encapsulation body 102. Here, the exposed part of inductive element 103 may be set on the upper surface and lower surface of encapsulation body 102, and the exposed part of inductive element 103 on the lower surface of encapsulation body 102 can be encapsulated in encapsulation body 101.

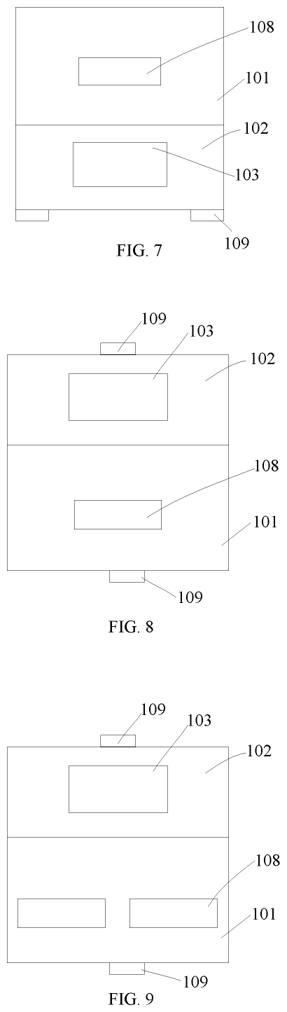

Referring now to FIG. 7, shown is a cross-sectional diagram of a fifth example module structure, in accordance with embodiments of the present invention. In this particular example, second type structure 101 can be set on the upper surface of first type structure 102, inductive element 103 can be encapsulated in encapsulation body 102, non-inductive element 108 may be encapsulated in the encapsulation body 101, and the pin structures can be set on the surface of first type structure 102. That is, the pin structures can be set on the lower surface of encapsulation body 101. In other examples, the specific surface on which the pin structures are set on encapsulation body 101 depends on particular application.

Referring now to FIG. 8, shown is a cross-sectional diagram of a sixth example module structure, in accordance with embodiments of the present invention. In this particular example, the input pins and output pins can respectively be set on the upper surface of the first type structure and the lower surface of the first type structure. In addition, the pin structures (input pin and output pin) may be set on a particular surface of encapsulation bodies 101 and 102 according to the actual application.

Referring now to FIG. 9, shown is a cross-sectional diagram of a seventh example module structure, in accordance with embodiments of the present invention. In this particular example, the module structure can include multiple non-inductive elements 108, and two non-inductive elements 108 are utilized. In other examples, the number of non-inductive elements 108 can be 3 or 4, or even more non-inductive elements 108 may be encapsulated in the second encapsulation body. For example, the two non-inductive elements 108 can be electrically connected through corresponding electrodes. In this example, non-inductive elements are dies, and the two dies are arranged side by side. In other examples, two dies can also be arranged up and down, and there is no restriction on the arrangement of the two dies in certain embodiments.

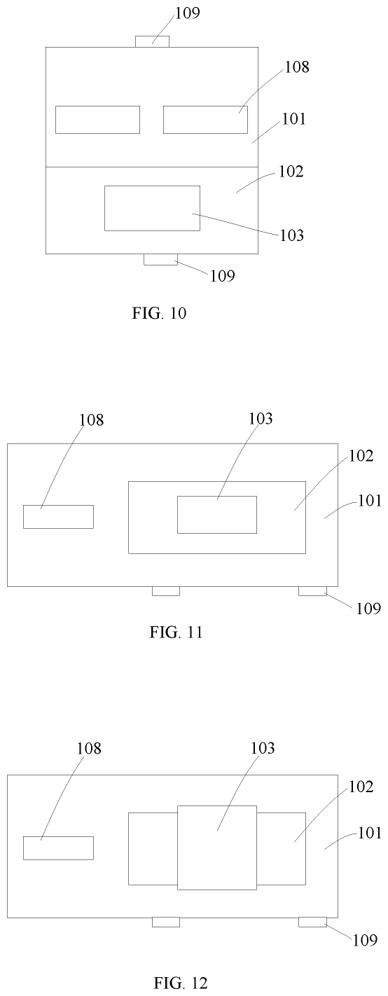

Referring now to FIG. 10, shown is a cross-sectional diagram of an eighth example module structure, in accordance with embodiments of the present invention. In this particular example, encapsulation body 101 of the module structure can be placed on the upper end of encapsulation body 102. For example, encapsulation body 101 may be encapsulated with two non-inductive elements 108. In this example, non-inductive elements 108 can include dies, and the two dies are arranged side by side. In other examples, the two dies can also be arranged up and down, and there is no restriction on the arrangement of the two dies in certain embodiments.

Referring now to FIG. 11, shown is a cross-sectional diagram of a ninth example module structure, in accordance with embodiments of the present invention. In this particular example, encapsulation body 102 may fully encapsulate inductive element 103. Non-inductive element 108 and encapsulation body 102 can be encapsulated within encapsulation body 101, and the pin structures may be set on the surface of encapsulation body 101. In this example, the pin structures can be set on the lower surface of encapsulation body 101. In other examples, the pin structures can be set on other surfaces of encapsulation body 101, without limiting the specific position of the pin structure setting. In this example, encapsulation body 102 and non-inductive element 108 may be arranged side by side within encapsulation body 101. In other embodiments, encapsulation body 102 and non-inductive element 108 can be arranged up and down, and their particular arrangement is not limited in certain embodiments.

Referring now to FIG. 12, shown is a cross-sectional diagram of a tenth example module structure, in accordance with embodiments of the present invention. In this particular example, encapsulation body 102 may partially encapsulate the inductive element, and inductive element 103 may have exposed parts on the upper surface and lower surface of encapsulation body 102.

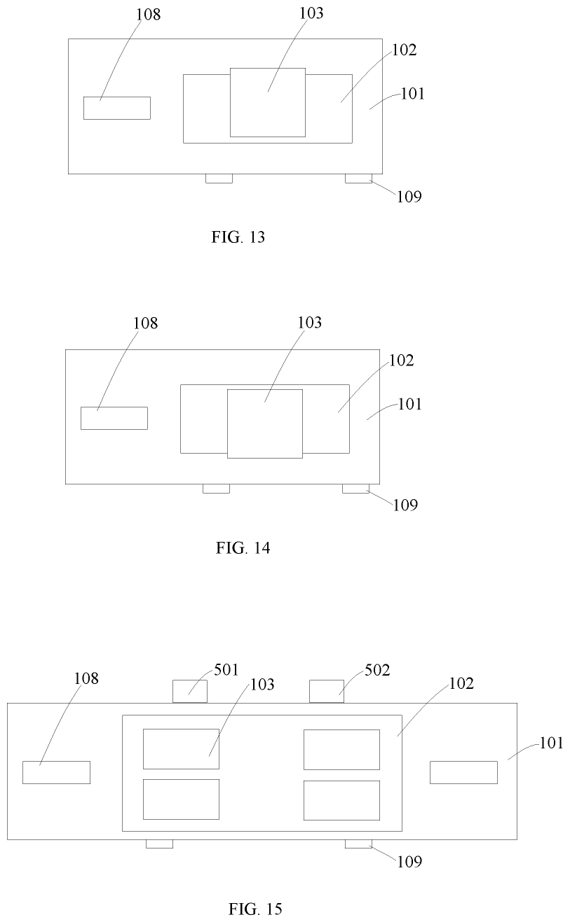

Referring now to FIG. 13, shown is a cross-sectional diagram of a eleventh example module structure, in accordance with embodiments of the present invention. In this particular example, encapsulation body 102 can partially encapsulate the inductive element, and part of inductive element 103 may be exposed on the upper surface of encapsulation body 102.

Referring now to FIG. 14, shown is a cross-sectional diagram of a twelfth example module structure, in accordance with embodiments of the present invention. In this particular example, encapsulation body 102 may partially encapsulate the inductive element, and the part of inductive element 103 can be exposed on the lower surface of encapsulation body 102.

Referring now to FIG. 15, shown is a cross-sectional diagram of a thirteenth example module structure, in accordance with embodiments of the present invention. In this particular example, four inductive elements 103 can be encapsulated inside encapsulation body 102, which may be electrically connected to each other. Two non-inductive elements 108 and encapsulation body 102 may both be encapsulated inside encapsulation body 101, and the pin structures can be set on the lower surface of encapsulation body 101, and electrically connected to the inductive elements 103 and non-inductive elements 108, respectively. In this example, two non-inductive elements 108 can respectively be arranged on both sides of encapsulation body 102. In this example, encapsulation body 102 and two non-inductive elements 108 may be arranged side by side in encapsulation body 101. In other examples, encapsulation body 102 and non-inductive elements 108 can be arranged up and down, and there is no restriction on their particular arrangement in certain embodiments. In other examples, the number of inductive elements 103 can be set according to the particular application. In other examples, the number of non-inductive elements 108 is not limited, and the number of non-inductive elements 108 can be set according to the particular application. In other examples, two non-inductive elements 108 can also be placed on the same side of encapsulation body 102.

The specific position of non-inductive elements 108 may be set according to the particular application. In this example, the module structure can also include resistor device 501 and capacitor device 502. Resistor device 501 and capacitor device 502 can be placed on the upper surface of the second encapsulation body, and resistor device 501 and capacitor device 502 may be electrically connected to non-inductive element 108 or inductive element 103, respectively. Resistive device 501 and capacitive device 502 can be placed on any outer surfaces of encapsulation body 101. The specific positions of resistive device 501 and capacitive device 502 are not limited in certain embodiments.

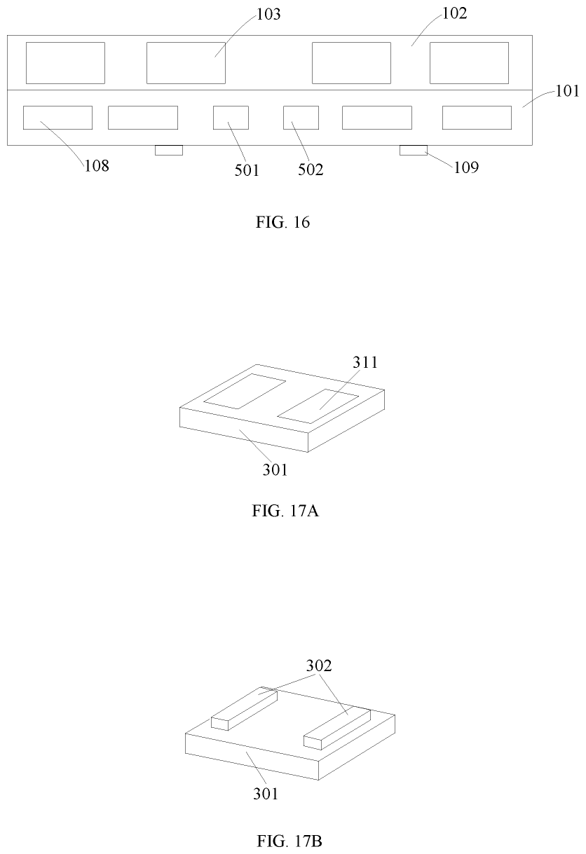

Referring now to FIG. 16, shown is a cross-sectional diagram of a fourteenth example module structure, in accordance with embodiments of the present invention. In this particular example, four non-inductive elements 108 can be encapsulated inside encapsulation body 101. Encapsulation body 102 may encapsulate four inductive elements 103, and encapsulation body 102 can be placed on the upper end of encapsulation body 101. Resistor device 501 and capacitor device 502 may further be encapsulated inside encapsulation body 101. In this embodiment, two non-inductive elements 108 can be arranged at the left half of encapsulation body 101, and the other two non-inductive elements 108 can be arranged at the right half of the encapsulation body 101. Resistive device 501 and capacitive device 502 may be located between the middle two non-inductive elements 108. In other examples, the position of non-inductive elements 108 and the positions of resistive device 501 and capacitive device 502 are not limited and can be set according to the particular application.

Referring now to FIG. 2, shown is a three-dimensional structural diagram of a first type structure, in accordance with embodiments of the present invention. In this particular example, metal connection structure 330 can be included and encapsulated in encapsulation body 102. Also, metal connection structure 330 can be exposed on the first surface of the first encapsulation body, and metal connection structure 330 may be electrically connected to inductive element 108.

Particular embodiments can also include a first metal connection structure encapsulated in the second encapsulation body. The first metal connection structure can be exposed on the second surface of the second encapsulation body, and the first metal connection structure may be electrically connected to the non-inductive element. The first surface of the first encapsulation body may be adjacent to the second surface of the second encapsulation body, and the first metal connection structure and the third metal connection structure can be electrically connected correspondingly.

Further, the area of the surfaces (i.e., the first and second surfaces) on which encapsulation bodies 101 and 102 come into contact with each other may roughly be the same; that is, an area of the first surface can be approximately identical with that of the second surface. The material of encapsulation body 101 may be different from that of encapsulation body 102. The material of encapsulation body 102 can include magnetic material, and the material of encapsulation body 101 is an insulating material, which can include various PCB boards, ceramic materials, and packaging substrate BT boards, in addition to conventional epoxy resin packaging materials. The material of encapsulation body 102 can include an insulating main material and magnetic particles dispersed in the insulating main material. For example, the insulating main material can include at least one of epoxy resin, phenolic resin, cyanate ester, polyester resin, bismaleimide, and silicone resin. The encapsulation material of encapsulation body 102 can include alloy particles containing elements such as Fe, Si, NI, Cr, AL, Cu, etc. The magnetic particles can include at least one of carbonyl iron powder, alloy powder, micro-particle broken ferrite powder, and amorphous nanocrystalline powder.

In particular embodiments, encapsulation body 102 may fully encapsulate inductive element 108, such that inductive element 108 is not exposed. The first metal connection structure and metal connection structure 330 can connect one by one to achieve electrical connection between the die and the inductive element. For example, the first metal connection structure and metal connection structure 330 can be arranged parallel to each other in a vertical direction. In this example, the module structure can also include pin structures, which may be electrically connected to the non-inductive element or inductive element 108. The pin structures can achieve electrical connection between the module structure and external circuits.

In particular embodiments, the inductive element can be an inductor, which may be arranged in a square shape, equivalent to a single turn magnetic structure. In other examples, as shown in FIG. 2, inductive element 108 can also be arranged in an “S” shape, which is equivalent to a magnetic structure larger than 1 turn. In addition, inductive element 108 can also be set as a spiral, straight line, broken line, irregular curve, etc. The number of turns is not limited to single or multiple turns, and there is no restriction thereto in certain embodiments.

In particular embodiments, encapsulation body 102 may fully encapsulate inductive element 108. In other examples, encapsulation body 102 can partially encapsulate inductive element 108. In this example, the first type structure can be set on the upper end of the second type structure, while in other examples, the first type structure can be set on the lower end of the second type structure. In particular embodiments, the inductive element can completely occupy the upper surface or the lower surface of the first encapsulation body, and the space more reasonably utilized, such that the module structure is thinner and smaller in size.

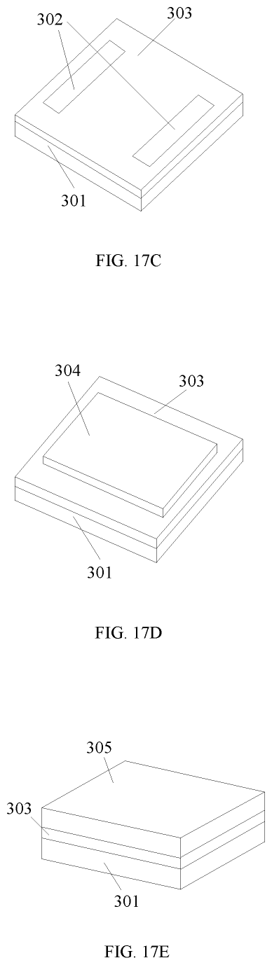

Referring now to FIGS. 17A-17E, shown are structural diagrams corresponding to certain steps of a manufacturing method for a module structure, in accordance with embodiments of the present invention. Formation of a module structure can include forming a first type structure by encapsulating an inductive element with a first encapsulation body having magnetic property, forming a second type structure by encapsulating non-inductive element with a second encapsulation material having nonmagnetic property, and setting the pin structures on exposed surfaces of the first type structure and/or the second type structure, whereby the pin structures can lead out the corresponding electrode. Also, the first type structure can be set on an upper end or lower end of the second type structure. For example, the second type structure may be on the upper end or lower end of the first type structure, and the pin structures can be on the surface of the first type structure. The first type structure can be set inside the second type structure, and the pin structures can be set on one of exposed surfaces of the second type structure. The inductive element may be fully encapsulated in the first encapsulation body. For example, part of the inductive element can be exposed on the upper surface and/or lower surface of the first encapsulation body when forming a first type structure.

The method can also include setting capacitors and/or resistors on the surface of the second encapsulation body. The method can also include encapsulating a third metal connection structure and the inductive element structure together in the first encapsulation body, and exposing the third metal connection structure on the first surface of the first encapsulation body, whereby the third metal connection structure is electrically connected to the inductive element. The method can also include encapsulating a first metal connection structure and the non-inductive element together in the second encapsulation body, and exposing the first metal connection junction on the second surface of the second encapsulation body, whereby the first metal connection structure is electrically connected to the non-inductive element. The first surface of the first encapsulation body can be adjacent to the second surface of the second encapsulation body, and the first metal connection structure and the third metal connection structure can be electrically connected correspondingly.

A first encapsulation body can be used to encapsulate a die. Also, an inductive element can be installed on the first encapsulation body and may encapsulate the inductive element using a second encapsulation body. The first encapsulation body can include a first surface and a second surface, the first surface can include a first metal connection structure, and the second surface can include a patterned second metal connection structure that is exposed and electrically connected to the die to be electrically connected to an external circuit. The second encapsulation body can include a third surface adjacent to the first surface, and can include an exposed patterned third metal connection structure. The first metal connecting structure and the third metal connection structure can be electrically connected to each other.

As shown in FIG. 17A, encapsulation body 301 can encapsulate the die. For example, encapsulation body 301 can include opposite first and second surfaces, metal connection structure 311 may be formed on the first surface, and an exposed patterned second metal connection structure may be formed on the second surface for electrical connection with external circuits. Encapsulation body 301 can include an insulating material.

As shown in FIG. 17B, metal connection structure 302 can be formed on encapsulation body 301, which may lead-out terminals of the inductive component. Metal connection structure 302 can be formed using an electroplating process, and can connect to the corresponding pins (e.g., metal connection structure 311) of the die. Metal connection structure 302 can be made of copper material. In this example, metal connection structure 302 is a square structure, but can alternatively be any suitable shape can be utilized in certain embodiments.

As shown in FIG. 17C, encapsulation body 303 may be formed on encapsulation body 301 to encapsulate metal connection structure 302. Encapsulation body 303 can be flush with the upper surface of metal connection structure 302; that is, encapsulation body 303 may expose the upper surface of metal connection structure 302.

As shown in FIG. 17D, winding body 304 of an inductive element can be formed on metal connection structure 302 and encapsulation body 303. Winding body 304 of the inductive element may be formed using an electroplating process, and the shape of winding body 304 can be set to be square, “S” shaped (see, e.g., FIG. 2), or spiral. Winding body 304 can be a metal material (e.g., copper material).

As shown in FIG. 17E, encapsulation body 305 can be formed on encapsulation body 303 to encapsulate at least a portion of the inductive element. For example, encapsulation body 305 can completely encapsulate the inductive element, or at least expose the upper surface of the inductive element for better heat dissipation. For example, the second encapsulation body can include encapsulation bodies 303 and 305. The second encapsulation body can include an insulating main material and magnetic particles dispersed in the main material. The magnetic particles can include at least one of carbonyl iron powder, alloy powder, micro-particle broken ferrite powder, and amorphous nanocrystalline powder.

Particular embodiments may also provide a manufacturing method for a second module structure. The method can include welding the formed inductive element directly onto metal connection structure 311 exposed by encapsulation body 301 in FIG. 17A. The inductive element can be an already formed structure, and the inductive element can include a third metal connection structure and a winding body. The third metal connection structure and metal connection structure 311 can connect in a one-to-one correspondence. The method can also include forming a second encapsulation body on encapsulation body 301 in FIG. 17A to encapsulate the inductive element. The second encapsulation body can completely encapsulate the inductive element, or at least expose the upper surface of the inductive element. For example, the second encapsulation body can include an insulating main material and magnetic particles dispersed in the main material. The magnetic particles can include at least one of carbonyl iron powder, alloy powder, micro-particle broken ferrite powder, and amorphous nanocrystalline powder.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A module structure, comprising:
a) a first type structure comprising a first encapsulation body having a magnetic property, and at least one inductive element, wherein at least part of the inductive element is encapsulated in the first encapsulation body;
b) a second type structure comprising a second encapsulation body having a non-magnetic property, and at least one non-inductive element, wherein the non-inductive element is encapsulated in the second encapsulation body; and
c) pin structures located on exposed surfaces of the first type structure and/or the second type structure, in order to lead out corresponding electrodes.

2. The module structure of claim 1, wherein the first type structure is arranged on the second type structure, and the pin structures are arranged on at least one exposed surface of the second type structure.

3. The module structure of claim 1, wherein the second type structure is arranged on the first type structure, and the pin structures are arranged on at least one exposed surface of the first type structure.

4. The module structure of claim 1, wherein the pin structures are respectively arranged on the surface of the first type structure and the surface of the second type structure.

5. The module structure of claim 1, wherein the first type structure is arranged inside the second type structure, and the pin structures are arranged on at least one surface of the second type structure.

6. The module structure of claim 1, wherein the inductive element is completely encapsulated in the first encapsulation body.

7. The module structure of claim 1, wherein the at least part of the inductive element is encapsulated in the first encapsulation body and remaining part of the inductive element is exposed at the upper surface and/or lower upper surface of the first encapsulation body.

8. The module structure of claim 1, further comprising capacitors and/or resistors arranged on the surfaces of the second encapsulation body.

9. The module structure of claim 1, wherein the inductive element is configured as one of a transformer or an inductor.

10. The module structure of claim 1, wherein the non-inductive element comprises one or more of a resistor, a capacitor, and a die.

11. The module structure of claim 1, further comprising:
a) a third metal connection structure encapsulated in the first encapsulation body, wherein the third metal connection structure is exposed on a first surface of the first encapsulation body, and the third metal connection structure is electrically connected to the inductive element;
b) a first metal connection structure encapsulated in the second encapsulation body, wherein a first metal connection structure is exposed on a second surface of the second encapsulation body, and the first metal connection structure is electrically connected to the non-inductive element; and
c) wherein the first surface of the first encapsulation body is adjacent to the second surface of the second encapsulation body, and the first metal connection structure and the third metal connection structure are electrically connected correspondingly.

12. The module structure of claim 11, wherein the first metal connection structure and the third metal connection structure are arranged parallel to each other in a vertical direction.

13. The module structure of claim 11, wherein an area of the first surface is approximately identical with that of the second surface.

14. The module structure of claim 1, wherein the first encapsulation body is formed by magnetic material comprising an insulating main material and magnetic particles dispersed in the insulating main material.

15. The module structure of claim 14, wherein the magnetic particles include at least one of carbonyl iron powder, alloy powder, micro-particle broken ferrite powder, and amorphous nanocrystalline powder.

16. A method of manufacturing a module structure, the method comprising:
a) forming a first type structure by encapsulating an inductive element with a first encapsulation body having magnetic property;
b) forming a second type structure by encapsulating non-inductive element with a second encapsulation material having nonmagnetic property; and
c) setting pin structures on exposed surfaces of the first type structure and/or the second type structure, wherein the pin structures are used to lead out corresponding electrodes.

17. The method of claim 16, further comprising setting the first type structure on an upper end or lower end of the second type structure.

18. The method of claim 16, further comprising setting the first type structure inside the second type structure, and setting the pin structures on one of exposed surfaces of the second type structure.

19. The method of claim 16, wherein the inductive element is completely encapsulated in the first encapsulation body.

20. The method of claim 16, wherein part of the inductive element is exposed on the upper surface and/or lower surface of the first encapsulation body when forming a first type structure.
